(19) United States
(12) Patent Application Publication
(10) Pub. No.: US 2014/0023242 A1
(43) Pub. Date: Jan. 23, 2014

(54) RECOGNITION DICTIONARY PROCESSING APPARATUS AND RECOGNITION DICTIONARY PROCESSING METHOD

(71) Applicant: TOSHIBA TEC KABUSHIKI KAISHA, Tokyo (JP)

(72) Inventor: Hiroshi Sugasawa, Miyagi-ken (JP)

(21) Appl. No.: 13/939,429

(22) Filed: Jul. 11, 2013

(30) Foreign Application Priority Data
Jul. 23, 2012 (JP) 2012-162961

(51) Int. Cl. G06K 9/00

(52) U.S. Cl. CPC G06K 9/00624
USPC 382/110

(57) ABSTRACT

A recognition dictionary processing apparatus compares the data of the feature amount extracted from a commodity image with the feature amount data in a recognition dictionary file to recognize a candidate for the commodity contained in the image and outputs the recognized candidate commodity. The apparatus executes a first processing related to the update of the recognition dictionary file of the processing object if the commodity contained in the image is does not exist in the candidate commodities or a second processing unrelated to the update of the recognition dictionary file of the processing object if the commodity contained in the image exists in the candidate commodities.

### CROSS-REFERENCE TO RELATED APPLICATION

This application is based upon and claims the benefit of priority from Japanese Patent Application No. 2012-162961, filed Jul. 23, 2012, the entire contents of which are incorporated herein by reference.

### FIELD

Embodiments described herein relate to a recognition dictionary processing apparatus and a recognition dictionary processing method.

### BACKGROUND

A technology is known which extracts the feature amount of a target object from the image data of the object captured by an image capturing section, compares the extracted feature amount with the feature amount data registered in a recognition dictionary file to calculate a similarity degree, and recognizes the category of the object according to the similarity degree. The recognition of an object contained in such an image is referred to as generic object recognition, which is realized using the technologies described in following document:

YANAI Keiji, ‘The current state and further directions on Generic Object Recognition’, in Proceedings of Information Processing Society of Japan, Vol. 48, No SIG 16, In URL: http://mm.cs.uec.ac.jp/IPSJ-TCVIM-Yanai.pdf [retrieved on Aug. 10, 2010].

In addition, the technology carrying out generic object recognition through regional image segmentation for each object is described in following document:

Jamie Shotton: “Semantic Texton Forests for Image Categorization and Segmentation, In URL:http://citeseerx.ist.psu.edu/viewdoc/download?doi=10.1. 1.145.3036&rep=rep1&type=pdf (retrieved on Aug. 10, 2010).

It is proposed in recent years to apply a generic object recognition technology to a recognition apparatus for recognizing a commodity affixed with no barcode such as vegetable and fruit and purchased by a customer in a settlement system (POS system) set in a retail shop. In this case, feature amount data, which represents the surface information, such as appearance and shape, tone, pattern and uneven-even situation, of a recognition object commodity with parameters, is stored in a recognition dictionary file. A commodity recognition apparatus extracts the appearance feature amount of the commodity from the image data of the commodity captured by an image capturing module and compares the extracted feature amount with the feature amount data of each commodity registered in the recognition dictionary file. Moreover, the commodity recognition apparatus outputs a commodity having similar feature amount as a recognition commodity candidate.

### BRIEF DESCRIPTION OF THE DRAWINGS

FIG. 1 is a diagram illustrating the main portion configurations of a chain store system according to an embodiment;

FIG. 2 is a block diagram illustrating the functional components of a shop server;

FIG. 3 is a schematic diagram illustrating the structure of dictionary data;

FIG. 4 is a schematic diagram illustrating the structure of dictionary management data;

FIG. 5 is a block diagram illustrating the hardware configurations of a shop server;

FIG. 6 is a flowchart illustrating the first half part of the information processing executed by the CPU of a shop server according to a recognition dictionary processing method;

FIG. 7 is a flowchart illustrating the second half part of the information processing executed by the CPU of a shop server according to a recognition dictionary processing method;

FIG. 8 is a flowchart illustrating detailed procedures of recognition processing in the self-shop dictionary shown in FIG. 6;

FIG. 9 is a diagram illustrating an example of a candidate commodity list screen;

FIG. 10 is a diagram illustrating an example of a screen updating unnecessary message;

FIG. 11 is a diagram illustrating an example of a candidate commodity list screen;

FIG. 12 is a diagram illustrating an example of a retrieval confirmation screen.

### DETAILED DESCRIPTION

According to one embodiment, a recognition dictionary processing apparatus includes an extraction module, a candidate recognition module, an output module and a processing module. The extraction module configured to extract the feature amount of the commodity contained in the image captured. The candidate recognition module configured to compare the feature amount data stored in a recognition dictionary file in which feature amount data of commodities are stored to recognize the candidate of the commodity contained in the image. The output module configured to output the candidate commodity which is recognized by the candidate recognition module as a candidate for the commodity contained in the image. The processing module configured to execute a first processing related to the update of the recognition dictionary file of the processing object if the commodity contained in the image does not exist in the candidate commodities output by the output module, a second processing unrelated to the update of the recognition dictionary file of the processing object if the commodity contained in the image exists in the candidate commodities.

Embodiments of the recognition dictionary processing apparatus are described in detail below with reference to accompanying drawings. Further, in the embodiments, the shop server set in each shop of the chain stores in the headquarters integrating a plurality of shops can function as a recognition dictionary processing apparatus.

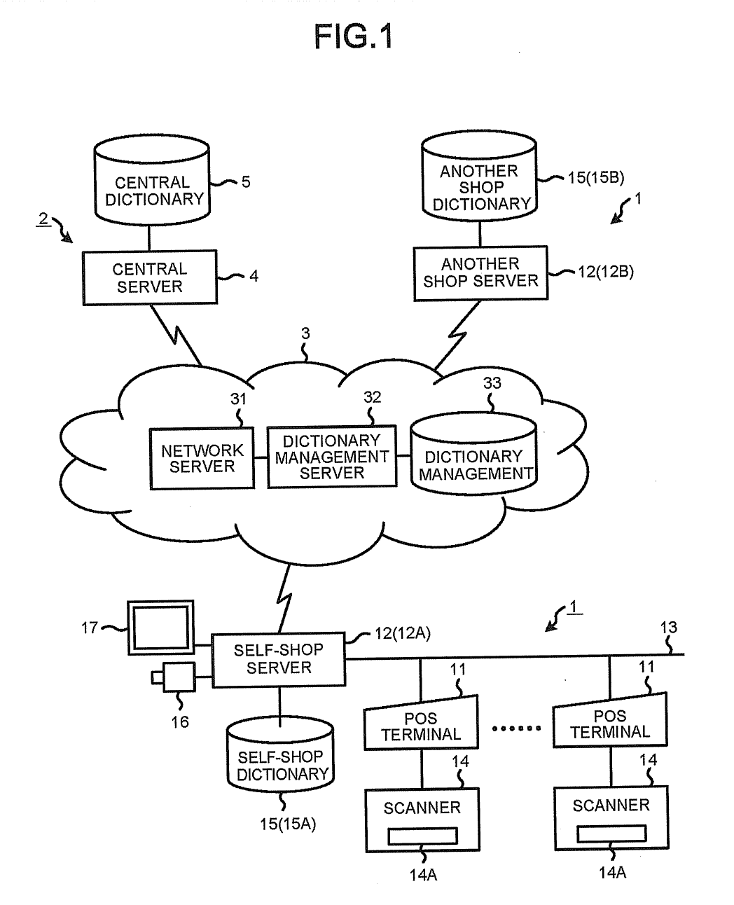

FIG. 1 is a diagram illustrating the main portion configurations of a chain store system. The chain store system includes a POS system 1 installed in each shop, a headquarters system 2 installed in the headquarters and a cloud system 3 taking the Internet as the main body. A free bilateral communication can be achieved between Each POS system 1 is connected with the headquarters system 2 in a manner that can communicate bilateral freely via the cloud system 3.

The POS system 1 includes a plurality of POS terminals 11 and a shop server 12. Each POS terminal 11 is connected with the shop server 1 via a wired or wireless LAN (Local Area Network) 13. Each POS terminal 11 carries out a sales processing on the sales data of the commodities purchased by a customer. The shop server 12 collects and totalizes the sales data of each commodity on which each POS terminal 11 carries out a sales processing via the LAN 13 to manage the sales and the stock of the whole shop.

Each POS terminal 11 recognizes the commodities purchased by a customer using a generic object recognition technology. Therefore, each POS terminal 11 is connected with a scanner 14 provided with an image capturing section 14A, and a recognition dictionary file 15 is set on the shop server 12. Feature amount data representing the surface information such as appearance and shape, tone, pattern and uneven-even situation of a commodity serving as a recognition object is stored in the recognition dictionary file 15.

Each POS terminal 11 first cuts off, from the image captured by the image capturing unit 14A of the scanner 14, the area of the commodity contained in the image, and extracts the appearance feature amount of the commodity from the image of the commodity area. Sequentially, each POS terminal 11 compares the data of the appearance feature amount of the commodity with the feature amount data of each commodity registered in the recognition dictionary file 15 to calculate the similarity degree between the feature amounts for different commodities. Moreover, each POS terminal 11 selectively displays a commodity having a high similarity degree in feature amount as a candidate for the recognition commodity. If a commodity is optionally selected from the candidates for the recognition commodity, then each POS terminal 11 carries out a sales processing on the sales data of the commodity. Further, the similarity degree may also be a degree of coincidence (rate of coincidence) representing the degree of coincidence or a correlation value representing the degree of correlation. That is, the similarity degree may also be a value obtained based on the feature amount of the image captured by the image capturing section 14A and the feature amount stored in the recognition dictionary file 15.

The shop server 12 is provided with a Web browser to use the Web services of the cloud system 3. The cloud system 3 is also connected with a central server 4 assuming the center of the headquarters system 2. The central server 4 also has a recognition dictionary file 5, in which the feature amount data of each commodity sold in each shop is stored. Correspondingly, the feature amount data of each commodity sold in one store is stored in the recognition dictionary file 15 of the shop server 12. Here, the recognition dictionary file 5 of the central server 4 is placed as a primary file, and the recognition dictionary file 15 of each shop server 12 is placed as a local file.

The recognition dictionary file 5 of the central server 4 is referred hereinafter to as a central dictionary file 5, and the recognition dictionary file 15 of each shop server 12 is referred hereinafter to as a shop dictionary file 15. Further, if the shops are classified into a primary self-shop and other affiliated another shops, the shop server 12 of the self-shop is referred to as a self-shop server 12A and the shop dictionary file 15 of the self-shop is referred to as a self-shop dictionary file 15, and the shop server of another shop is referred to as another shop server 12B and the shop dictionary file 15 of the another shop is referred to as anther shop dictionary file 15B.

The cloud system 3 includes a network server 31 and a dictionary management server 32. The network server 31 and the dictionary management server 32 are connected capable of communicating with each other. The network server 31 controls the data communication between the central server 4 and each shop server 12 or between the self-shop server 12A and another shop server 12B.

The dictionary management server 32 has a dictionary management file 33 for storing the dictionary management data 33R which will be described later. The dictionary management server 3 assists a recognition dictionary processing function realized by the shop serve 12 by using the dictionary management data 33R stored in the dictionary management file 33.

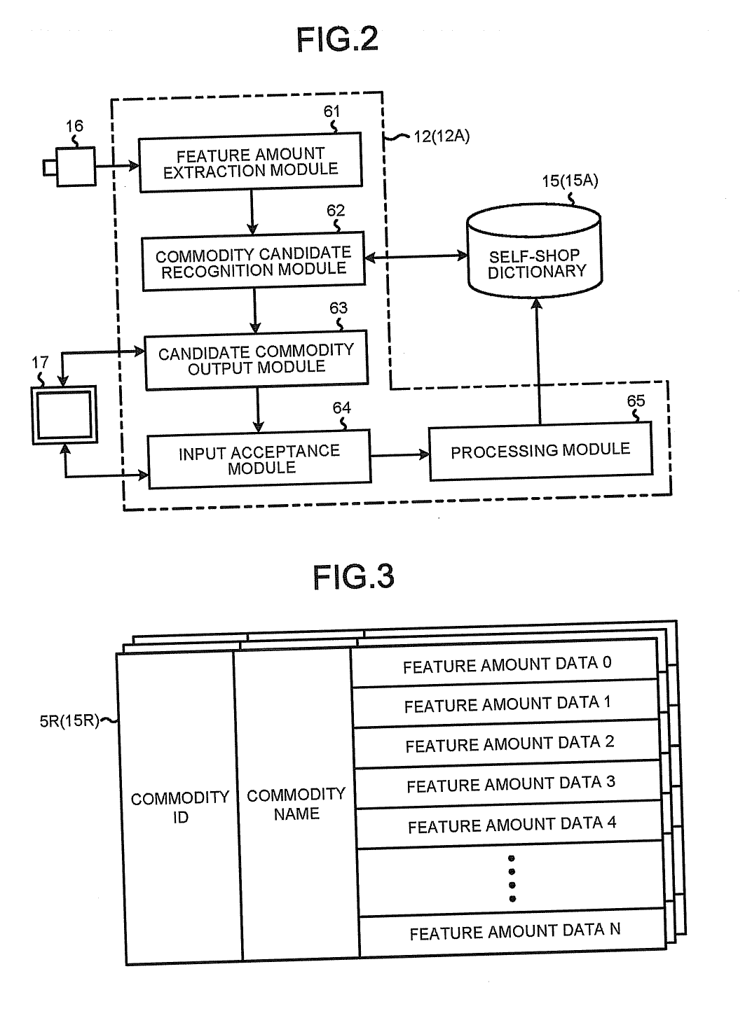

To realize a recognition dictionary processing function, the shop server 12 is connected with a digital video camera 16 serving as an image capturing module and a touch panel 17 serving as an operation/output module. In addition, by cooperating with software and hardware, the shop server 12, as shown in FIG. 2, comprises a feature amount extraction module 61, a commodity candidate recognition module 62, a candidate commodity output module 63, an input acceptance module 64 and a processing module 65.

The feature amount extraction module 61 extracts, from an image captured by the digital video camera 16, the appearance feature amount of the commodity contained in the image. The commodity candidate recognition module 62 compares the data of the appearance feature amount extracted by the feature amount extraction module 61 with the feature amount data in the self-shop dictionary file 15A to recognize a candidate for the commodity contained in the image. The candidate commodity output module 63 displays and outputs a candidate commodity which is recognized by the commodity candidate recognition module 62 as a candidate for the commodity contained in the image to the touch panel 17. The input acceptance module 64 accepts, from the touch screen 17, a selection input indicative of whether or not the commodity contained in the image exists in the candidate commodities displayed and output on the touch panel 17. The processing module executes, a first processing related to the update of the self-shop dictionary file 15A when the input acceptance module 64 accepts a selection input indicating of the nonexistence of the commodity contained in the image in the candidate commodities, and a second processing unrelated to the update of the self-shop dictionary file 15A when the input acceptance module 64 accepts a selection input indicative of the presence of the commodity contained in the image in the candidate commodities.

Here, the first processing includes the following processing of sending the data of the appearance feature amount extracted by the feature amount extraction module 61 to an external server connected through the cloud system 3, that is, the central server 4 or another shop server 12B, comparing the data of the feature amount with the feature amount in another recognition dictionary file, that is, the central dictionary file 5 or the another shop dictionary file 15B, to recognize a candidate for the commodity contained in the image, and acquiring the recognized candidate commodity.

In addition, the first processing includes the following processing of collecting, if any candidate commodity is selected from the candidate commodities acquired by the external server as the commodity contained in the image, the feature amount data of the selected candidate commodity from the another recognition dictionary file.

On the other hand, the second processing includes a processing of notifying the update of the self-shop dictionary file 15A is unnecessary.

FIG. 3 is a schematic diagram illustrating the structure of the dictionary data 5R (15R) stored in a recognition dictionary file, that is, the central dictionary file 5 or shop dictionary file 15. The dictionary data 5R stored in the central dictionary file 5 is structurally the same as the dictionary data 15R stored in the shop dictionary file 15.

As shown in FIG. 3, dictionary data 5R (15R) configuring at least a commodity ID and a commodity name for identifying a commodity and a plurality of feature amount data is stored in the recognition dictionary file 5(15). The feature amount data is data representing, using parameters, appearance feature amount of the surface information of a commodity recognized by a corresponding commodity ID, and the feature amount data 0-N obtained by observing a commodity from various directions are stored respectively. Further, the number (N+1) of the feature amount data of a commodity is not fixed but changes with commodities.

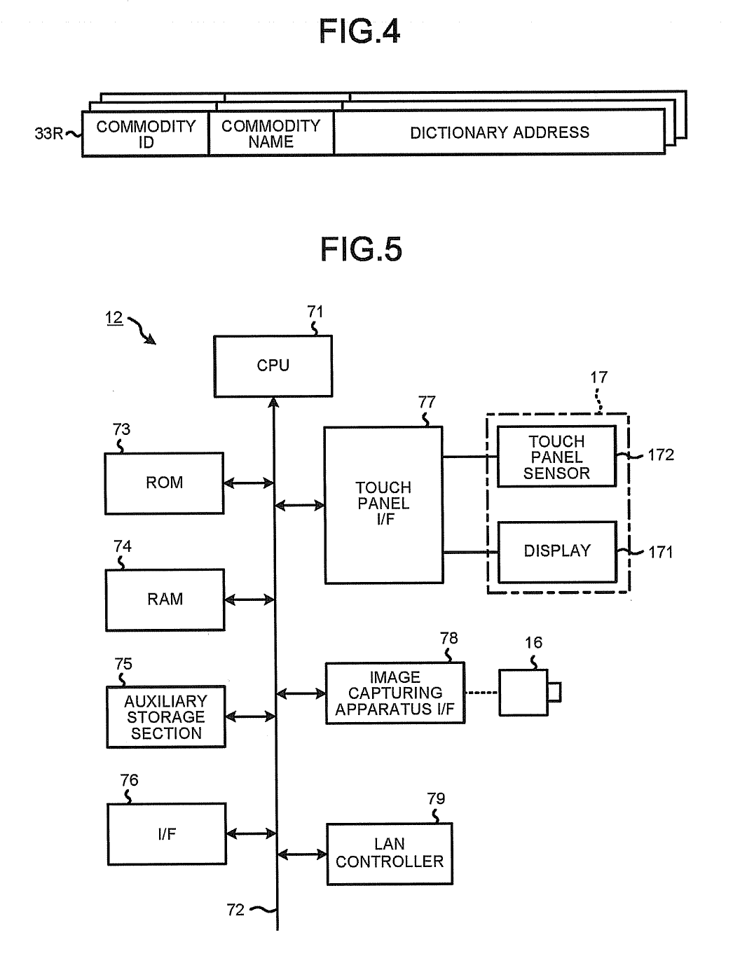

FIG. 4 is a schematic diagram illustrating the structure of the dictionary management data 33R stored in a dictionary management file 33. As shown in FIG. 4, dictionary management data 33R configuring at least a commodity ID and a commodity name for identifying a commodity and a dictionary address is stored in the dictionary management file 33. The dictionary address is fixed information set for each recognition dictionary file so as to recognize the recognition dictionary files respectively managed by the central server 4 and each shop server 12 (12A, 12B) connected through the cloud system 3, that is, to recognize the central dictionary file 5 and the shop dictionary file 15 (15A, 15B).

FIG. 5 is a block diagram illustrating the main portion configurations of the shop server 12. The shop server 12 is provided with a CPU (Central Processing Unit) 71 as the main body of a control section. Moreover, the CPU 71 of the shop server 12 is connected with a ROM (Read Only Memory) 73 and a RAM (Random Access Memory) 74 configuring a primary storage section and an auxiliary storage section 75 via a bus line 72 such as an address bus line or data bus line. Further, the shop server 12 connects an interface (I/F) 76, a touch panel interface 77, an image capturing apparatus interface 78 and a LAN controller 79 with the CPU 71 via the bus line 72.

The interface 76 is connected with the cloud system 3 via a communication circuit line to take charge of the data communication between the shop server 12 and the network server 31. The touch panel interface 77 is connected with the touch panel 17 via a communication cable. The touch panel 17 includes a display 171 capable of displaying a screen and a touch panel sensor 172 overlapped on the screen of the display 171 to detect a touch position coordinate on the screen. The touch panel interface 77 transmits display image data to the display 171 and receives a touch position coordinate signal from the touch panel sensor 172. The image capturing apparatus interface 78 is connected with the digital video camera 16 via a communication cable to acquire the image data captured by the camera 16. The LAN controller 79 controls the data communication between each POS terminal 11 and the shop server 12 which are connected with each other via the LAN 13.

Fixed data including basic programs and various setting data are stored in the ROM 73 in advance. A necessary memory area at least for realizing a recognition dictionary processing function by the shop server 12 is formed in the RAM 74. For example, various applications programs or totalized data are stored in the auxiliary storage section 75 which may be a HDD (Hard Disk Drive) or SDD (Solid State Drive). An application program for enabling the CPU 71 to achieve the aforementioned recognition dictionary processing function, that is, a recognition dictionary processing program, is also stored in the auxiliary storage section 75.

A recognition dictionary processing job is included in a job menu of the shop server 12 with the structure above. If the job is executed, a confirmation on whether or not the dictionary data 15R of a commodity serving as a recognized object is registered in the self-shop dictionary file 15A is made in the shop server 12 using a generic object recognition technology, if the dictionary data 15R of a commodity serving as a recognized object is not registered in the self-shop dictionary file 15A, the dictionary data 15R will be added to self-shop dictionary file 15A.

For example, the shop clerk in charge of commodity checking carries out such a job when a commodity of a recognition object is received in a shop. That is, if a commodity of a recognition object is received in a shop, the shop clerk in charge of commodity checking selects the recognition dictionary processing job from the job menu of the self-shop server 12A.

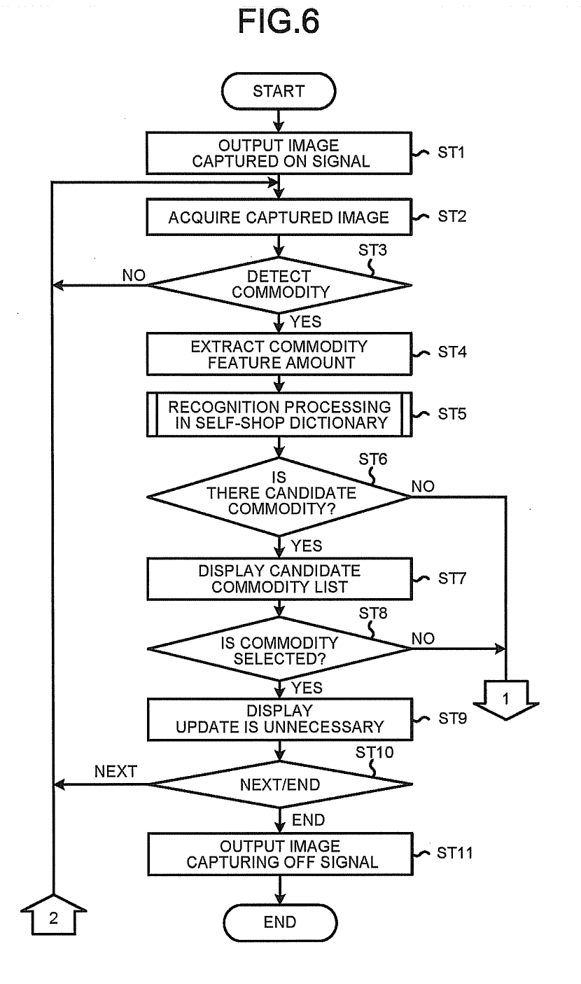

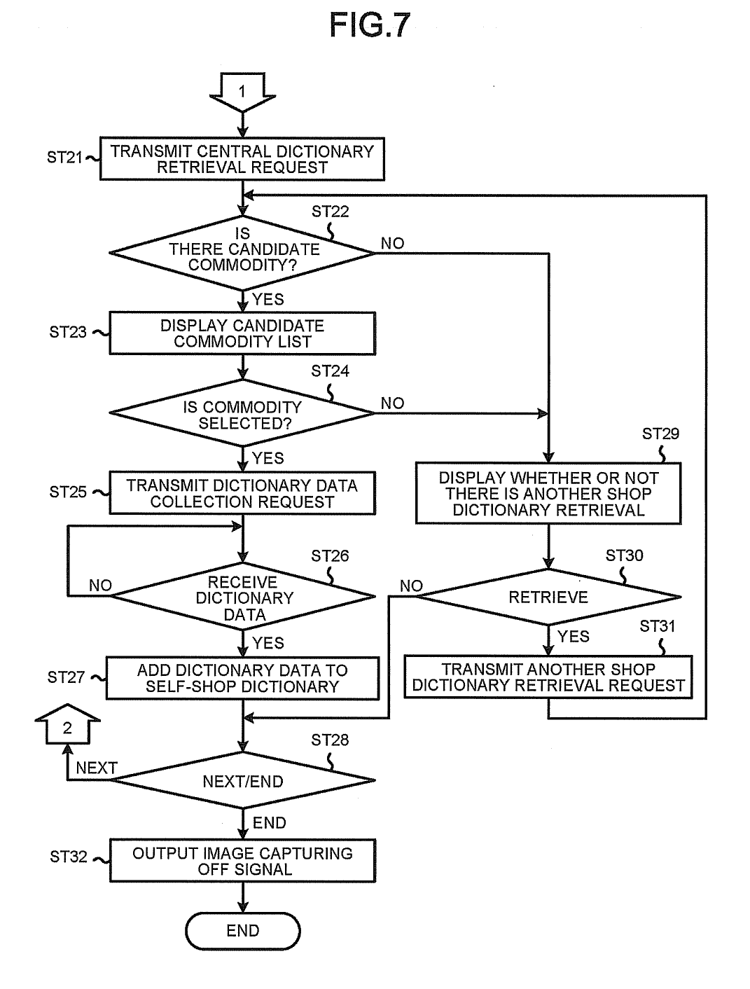

If the recognition dictionary processing job is selected, a recognition dictionary processing program is started in the self-shop server 12A. Then, the CPU 71 of the self-shop server 12A starts the procedures of the information processing shown in flowcharts of FIG. 6 and FIG. 7. First, the CPU 71 outputs a image captured on signal from the image capturing apparatus interface 78 (ST1). The digital video camera 16 starts to capture the image of an image capturing area according to the image captured on signal. The frame images of the image capturing area captured by the digital video camera 16 are sequentially stored in the RAM 74. Thus, the shop clerk in charge of commodity checking holds the commodity of a recognition commodity over the image capturing area captured by the digital video camera 16.

The CPU 71 acquires the data of the frame images stored in the RAM74 (ST2). Moreover, the CPU 71 confirms whether or not a commodity is detected from the frame image (ST3). Specifically, the CPU 71 extracts an outline from an image obtained by binarizing the frame image. Further, the CPU 71 attempts to extract the outline of the object reflected in the frame image. If the outline of the object is extracted, then the CPU 71 creates the mask image (an image configured by coating two colors on the inner or external side by taking the outline as a boundary) representing the position where an object recognition is actually carried out or processes the object part using a rectangular coordinate according to the outline of the object, thereby deeming the image in the outline as a commodity.

If no commodity is detected from the frame image (No in ST3), then the CPU 71 acquires the next frame image from the RAM 74 (ST2). Moreover, the CPU 71 confirms whether or not a commodity is detected from the frame image (ST3).

If a commodity is detected from the frame image (Yes in ST3), the CPU 71 extracts the feature amount on the appearance (appearance feature amount), such as the shape, the tone on the surface, the pattern, the uneven-even situation, of the commodity from the image in the outline (ST4: feature amount extraction module 61). The data of the extracted appearance feature amount is temporarily stored in the work area of the RAM 74.

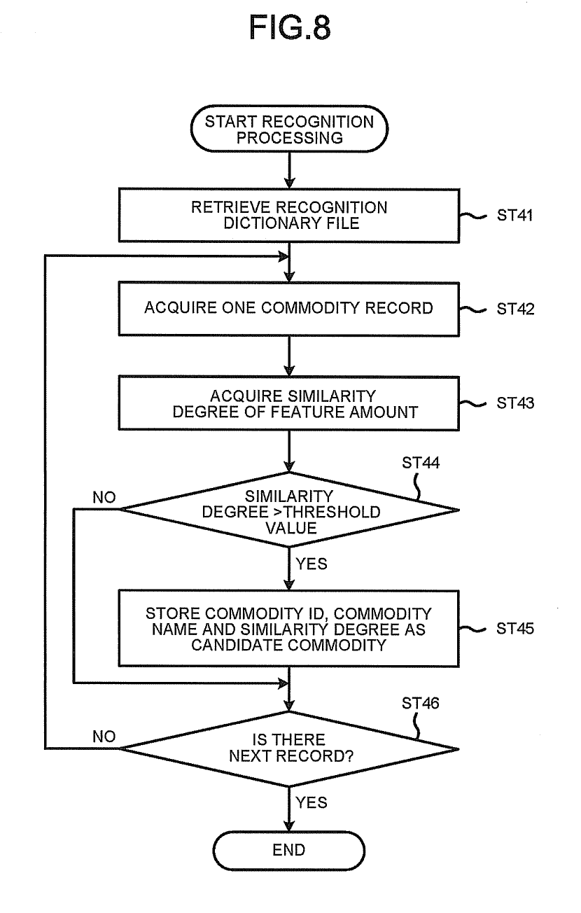

If the extraction of the feature amount is ended, the CPU executes a recognition processing in the self-shop dictionary (ST5). FIG. 8 is a flowchart illustrating detailed procedures of the recognition processing in the self-shop dictionary shown in FIG. 6. First, the CPU 71 retrieves the self-shop dictionary file 15A (ST41). Moreover, the CPU 71 reads the data record (commodity ID, commodity name, a plurality of feature amount data) of a commodity from the self-shop dictionary file 15A (ST42).

If the data record is read, the CPU 71 calculates the similarity degree representing how similar the data of the appearance feature amount extracted in the processing of ACT ST4 is to the feature amount data of the record (ST43). The greater the similarity degree is, the greater the similarity rate (degree) is. The upper limit value of the similarity degree is set to be 100 in this embodiment, and the similarity degree between the feature amount data is calculated for each commodity.

The CPU 71 confirms whether or not the similarity degree is greater than a given reference threshold value (ST44). The reference threshold value serves as the lower limit value of the similarity degree a commodity should have to be registered as a commodity candidate. As stated above, when the upper limit value of the similarity degree is set to be 100, the reference threshold value is set to be, for example, 20, which is ⅕ of the similarity degree. If the similarity degree is higher than the reference threshold value (Yes in ST44), the CPU 71 stores the commodity ID and the commodity name in the data record and the similarity degree calculated in the processing of ACT ST43 in a given area of the RAM 74 as a registered commodity candidate (ST45: commodity candidate recognition module 62). Here, if the similarity degree is not higher than the reference threshold value (No in ST44), the CPU 71 does not execute the processing of ACT ST45.

Then, the CPU 71 confirms whether or not there is an unprocessed data record in the self-shop dictionary file 15A (ST46). If there is an unprocessed data record in the self-shop dictionary file 15A (Yes in ST46), the CPU 71 returns to the processing of ACT ST42. That is, the CPU 71 reads the unprocessed data record from the self-shop dictionary file 15A and executes the processing of ACT ST43-ST46.

In this way, all commodity data records stored in the self-shop dictionary file 15A are subjected to the processing of ACT ST43-ST46, if a registered commodity candidate is recognized the similarity degree of which is higher than the reference threshold value (No in ST46), then the recognition processing in the self-shop dictionary is ended. If the recognition processing in the self-shop dictionary is ended, the CPU 71 confirms whether or not there is a registered commodity candidate (ST6).

If there is even only one commodity data (commodity code, commodity name, similarity degree) becoming a registered commodity candidate stored in the given area of the RAM 74, that is, there is more than one commodity candidates having a similarity degree greater than the given threshold value, then there is a registered commodity candidate. In this case (Yes in ST6), the CPU 71 activates the touch panel 17 to display a candidate commodity list screen on which the commodity name of a commodity becoming a candidate is arranged in descending orders of similarities (ST7: candidate commodity output module).

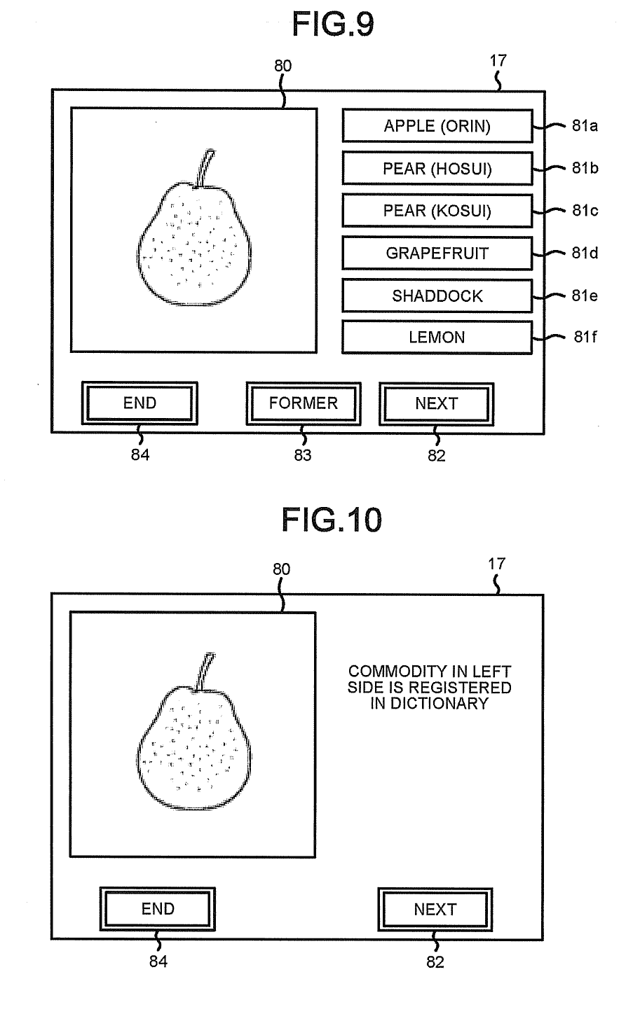

FIG. 9 is a diagram illustrating an example of a candidate commodity list screen. As shown in FIG. 9, the screen is classified into an area for a commodity image 80 and areas for a plurality of commodity name buttons 81a-81f. Further, touch buttons such as a button ‘Next’ 82, a button ‘Former’ 83 and a button ‘End’ 84 are arranged on the screen. The image of the commodity detected from the frame image acquired in the processing of ACT ST2 is displayed in the area 80. The name of each commodity becoming a registered commodity candidate is notated on each of the commodity name buttons 81a-81f according to appearance feature amount of the commodity displayed in the area 81. That is, the commodity names notated on the commodity name buttons 81a-81f become a candidate commodity list. The button ‘Next’ 82 and the button ‘Former’ 83 are touched when indicating update of the commodity names notated on the commodity name buttons 81a-81f. The button ‘End’ 84 is touched when a commodity name that should be selected is does not exist in the candidate commodity list.

The CPU 71 stands by until any commodity from the candidate commodity list is selected (ST8: input acceptance module)). If any one of the commodity name buttons 81a-81f is touched, then the CPU 71 deems that a commodity is selected from the candidate commodity list (Yes in ST8). At this time, the CPU 71 activates the touch panel 17 to display message notifying the update of self-shop dictionary file 15A is unnecessary (ST9: processing module)). Further, in the processing of Act ST6, when only one commodity data (commodity code, commodity name, similarity degree) becoming a registered commodity candidate is stored in the given area of the RAM 74, that is, there is only one commodity candidate having a similarity degree greater than the given threshold value, the flow may skip the processing in ACT ST7 and ACT ST8 and proceed to ACT ST9 to display, on the touch panel 17, subject notifying the update of self-shop dictionary file 15A is unnecessary.

FIG. 10 shows an example of the display of the aforementioned message. In this example, message ‘The commodity on the left is registered on the dictionary’ notifying the update is unnecessary is displayed nearby the right side towards to the screen of the area for a commodity image 80. Further, a button ‘Next’ 82 and a button ‘End’ 84 are arranged on the screen. Further, the content or display position of the information is not limited to the example shown in FIG. 10 as long as the subject notifying the update of the self-shop dictionary file 15A is unnecessary is sent to a user. The CPU 71 stands by until either of the button ‘Next’ 82 and the button ‘End’ 84 is input (ST10). When the button ‘Next’ 82 is touched (ST10: ‘next’), the CPU 71 returns to ACT ST2. That is, the CPU 71 acquires the next frame image from the RAM 74 and executes the processing following Act ST3 again.

When the button ‘End’ 84 is touched (ST10: ‘end’), the CPU 71 outputs image capturing off signal from the image capturing apparatus interface 78 (ST11). The digital video camera 16 ends the image capturing on the image capturing area according to the image capturing off signal.

Thus, when message notifying the update is unnecessary is displayed on the touch panel 17, the shop clerk holding the commodity of a recognition commodity over the digital video camera 16 can confirm that the dictionary data 15R of the recognition object commodity is registered in the self-shop dictionary file 15A. On the contrary, when a candidate commodity list screen is displayed on the touch panel 17, the shop clerk can confirm that the dictionary data 15R of the recognition object commodity is not registered in the self-shop dictionary file 15A.

In the processing of Act ST6, if there is no commodity data (commodity code, commodity name, similarity degree) becoming a registered commodity candidate stored in the given area of the RAM 74, that is, there is no commodity candidate having a similarity degree greater the given threshold value, then there is no registered commodity candidate. In this case (No in ST6), the CPU 71 proceeds to the processing of ACT ST21 (refer to FIG. 7) Further, the CPU 71 proceeds to the processing of ACT ST21 in the processing of Act ST8 even if the button ‘End’ 84 is touched (No in ST8).

In ACT ST21, the CPU 71 transmits a central dictionary retrieval command to the cloud system 3 via the interface 76, the command containing the data of the appearance feature amount obtained in processing of ACT ST4. The central dictionary retrieval command is transmitted to the central server 4 via the network server 31. The CPU of the central server 4 accepts the central dictionary retrieval command and executes a recognition processing in the central dictionary.

The procedures of the recognition processing in the central dictionary are the same as the procedures in ST41-ST46 shown in FIG. 8 except that the dictionary file of the retrieved object is changed to a central dictionary file 5 from the self-shop dictionary file 15A. That is, the CPU of the central server 4 compares the feature amount data of each dictionary data registered in the central dictionary file 5 with the data of the appearance feature amount contained in the central dictionary retrieval command to calculate a similarity degree for each commodity and recognizes the commodity the similarity degree of which is higher than the reference threshold value as a registered commodity candidate.

If the recognition processing in the central dictionary is ended, the CPU of the central server 4 transmits the commodity data (commodity code, commodity name, similarity degree) becoming a registered commodity candidate to the shop server 12A which is the transmitting source of the central dictionary retrieval command via the network server 31 of the cloud system 3. Further, if there is no commodity data becoming a registered commodity candidate, data indicative of no candidate commodity is transmitted to the same shop server 12A.

The CPU 71 of the shop server 12 transmitting the central dictionary retrieval command stands by until commodity data becoming a registered commodity candidate is received (ST22). When receiving commodity data becoming a registered commodity candidate (Yes in ST22), the CPU 71 activates the touch panel 17 to display a commodity list screen on which the commodity name of a commodity becoming a candidate in the central server 4 is arranged in descending orders of similarities (ST23).

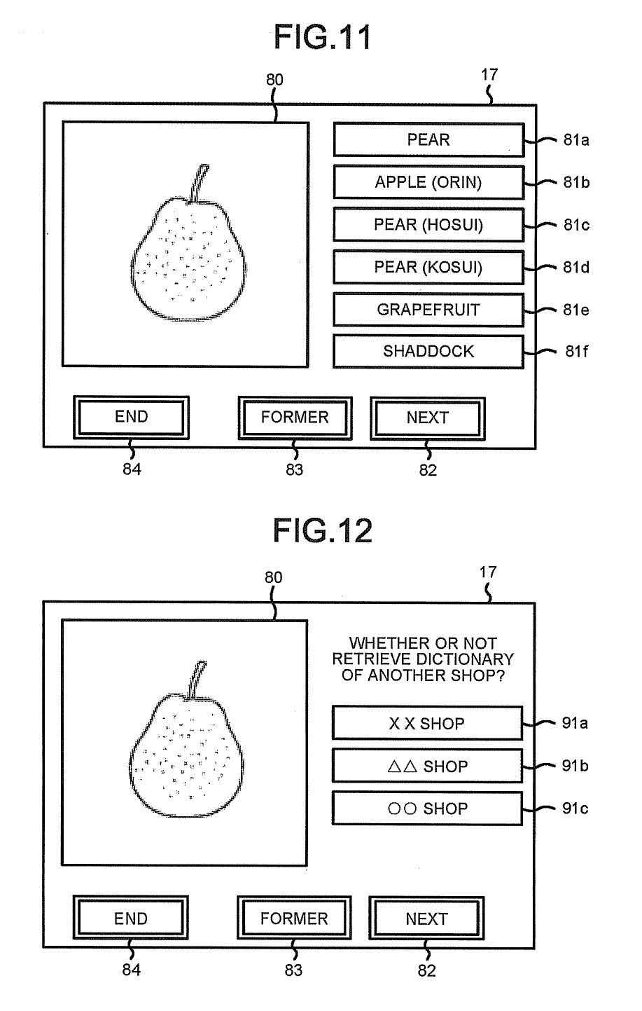

FIG. 11 is a diagram illustrating an example of a candidate commodity list screen displayed at the time of ACT ST 23. As shown in FIG. 11, the screen is the same as that displayed in Act ST7, that is, the screen is classified into an area for a commodity image 80 and areas for a plurality of commodity name buttons 81a-81f. Further, touch buttons, such as a button ‘Next’ 82, a button ‘Former’ 83 and a button ‘End’ 84, are arranged on the screen.

Further, the exemplary screens shown in FIG. 9 and FIG. 11 show that the shop clerk holds a commodity ‘pear’ over the digital video camera 16 of the self-shop server 12A. Dictionary data 15R of the commodity ‘pear’ is pre-stored in the central dictionary file 5, but not in the self-shop dictionary file 15A. In this case, as the commodity name ‘pear’ is not notated on the commodity name buttons 81a-81f, as shown in FIG. 9, the shop clerk touches the button ‘End’ 84. If so, as shown in FIG. 11, as the commodity name ‘pear’ is notated on the commodity name button 81a, the shop clerk touches the commodity name button 81a.

The CPU 71 stands by until any commodity from the candidate commodity list is selected (ST24). If any one of the commodity name buttons 81a-81f is selected, then the CPU 71 deems that a commodity from the candidate commodity list is selected (Yes in ST24). At this time, the CPU 71 transmits a dictionary data collection command to the cloud system 3 via the interface 76, the command containing the commodity ID of the commodity selected in the processing of ACT ST24.

The dictionary data collection command is transmitted to the dictionary management server 32 via the network server 31. The dictionary management server 32 retrieves the dictionary management file 33 and detects the dictionary management data 33R containing the commodity ID in the command received. If the matched dictionary management data 33 R is detected, then the dictionary management server 32 transmits a collection command of the dictionary data 5 R (15 R) containing the commodity ID in the command received to an external server (central server 4 or another shop server 12B) identified according to the dictionary address contained in the data.

The external server receiving the command reads, from a corresponding recognition dictionary file (central dictionary file 5 or another shop dictionary file 15B), dictionary data 5R (15R) containing the commodity ID contained in the command received and transmits the read dictionary data 5R (15R) to the dictionary management server 32. The dictionary management server 32 transmits the dictionary data 5R (15R) collected from the external server to the self-shop server 12A serving as the transmitting source of the dictionary data collection command via the network server 31.

The CPU 71 transmitting the dictionary data collection command stands by until the dictionary data 5R (15R) is received (ST26). If the dictionary data 5R (15R) is received via the interface 76, then the CPU 71 adds and registers the received dictionary data 5R (15R) to the self-shop dictionary file 15A (ST27: processing module 65).

Thus, if the dictionary data of the recognition object commodity is registered in the central dictionary file 5 but not the self-shop dictionary file 15A, then the dictionary data 5R of the central dictionary file 5 is added and registered to the self-shop dictionary file 15A. In this case, if the dictionary data 15R of the recognition object commodity is registered in the dictionary file 15B of another shop, the dictionary data 15R of the dictionary file 15B of another shop can also be added and registered to the self-shop dictionary file 15A as well. In this case, the feature amount data the same as that of the dictionary data 5R or 15R additionally registered will be deleted.

Then, the CPU 71 stands by until either of the button ‘Next’ 82 and the button ‘End’ 84 is inputted (ST28). When the button ‘Next’ 82 is touched (ST28: ‘next’), the CPU 71 returns to the processing of ACT ST2. That is, the CPU 71 acquires the next frame image from the RAM 74 and executes the processing following Act ST3 again.

On the other hand, when the button ‘End’ 84 is touched (ST28: ‘end’), the CPU 71 outputs a image capturing off signal from the image capturing apparatus interface 78 (ST32). The digital video camera 16 ends the image capturing on the image capturing area according to the image capturing off signal.

If data indicative of no candidate commodity is received in the processing of ACT ST22 (No in ST22) or the button ‘End’ 84 is touched in the processing of ACT ST24 (No in ST24), the CPU 71 displays, on the touch panel 17, a retrieval confirmation screen to confirm whether or not the recognition dictionary file of another shop is retrieved.

FIG. 12 is a diagram illustrating an example of a retrieval confirmation screen. As shown in FIG. 12, the screen is classified into an area for a commodity image 80 and areas for a plurality of shop name buttons 91a-91c. Further, touch buttons, such as a button ‘Next’ 82, a button ‘Former’ 83 and a button ‘End’ 84, are arranged on the screen. The image of the commodity detected from the frame image acquired in the processing of ACT ST2 is displayed in the area 80. The shop names of another shop in the same region preset in the auxiliary storage section 75 are notated on the shop name buttons 91a-91f.

For example, in the case which a commodity is limited by region, the dictionary data 5R is not registered in the central dictionary file 5, but the dictionary data 15R may be registered in the dictionary file 15B of another shop. In this case, the shop clerk touches the one of the shop name buttons 91a-91c which is notated with a desired shop name.

The CPU 71 displaying the retrieval confirmation screen stands by until either of the shop name buttons 91a-91c or the button ‘End’ 84 is touched (ST30). When either of the shop name buttons 91a-91c is touched, the CPU 71 deems that another shop of which name notated in the touched shop name buttons 91a-91c is selected. Moreover, the CPU 71 transmits a dictionary retrieval command of another shop to the cloud system 3 via the interface 76. The command contains the data of the appearance feature amount obtained in the processing of ACT ST4 and the recognition data of another shop selected from the retrieval confirmation screen. The dictionary retrieval command of another shop is transmitted to the matched another shop server 12B via the network server 31. The CPU 71 of another shop server 12B accepts the dictionary retrieval command of another shop and executes the recognition processing in the dictionary of another shop.

The procedures of the recognition processing in the central dictionary are the same as the procedures in ST41-ST46 shown in FIG. 8 except that the dictionary file of the retrieved object is changed to the dictionary file 15B of another shop from the self-shop dictionary file 15A. That is, the CPU 71 of another shop server 12B compares the feature amount data of each dictionary data registered in the another shop dictionary file 15B with the data of the appearance feature amount contained in the dictionary retrieval command of another shop to calculate a similarity degree for each commodity and recognizes a commodity the similarity degree of which is higher than the reference threshold value as a registered commodity candidate. If the recognition processing in the dictionary of another shop is ended, the CPU 71 of the another shop server 12B transmits the commodity data (commodity code, commodity name, similarity degree) becoming a registered commodity candidate to the shop server 12A which is the transmitting source of the dictionary retrieval command of another shop via the network server 31 of the cloud system 3. Further, if there is no commodity data becoming a registered commodity candidate, data indicative of no candidate commodity is transmitted to the shop server 12A of the same shop (request acceptance module).

The CPU 71 of the shop server 12 transmitting the dictionary retrieval command of another shop stands by until commodity data becoming a registered commodity candidate is received (ST22). Then, the CPU 71 carries out the processing following the processing of ACT ST22.

Thus, if the dictionary data of the recognition object commodity recognized is registered in another shop dictionary file 153 but not the central dictionary file 4, the dictionary data 15R of the another shop dictionary file 15B is added and registered to the self-shop dictionary file 15A.

In this way, according to one embodiment, the shop clerk in charge of commodity checking can easily confirm whether or not the dictionary data of the matched commodity is registered in the self-shop dictionary file 15A merely by holding the recognition object commodity over the image capturing area of the digital video camera 16. Moreover, the dictionary data registered in the central dictionary file 5 or another shop dictionary file 15B managed by an external server such as the central server 4 or the another shop server 12B, but not in the self-shop dictionary file 15A, is registered in the self-shop dictionary file 15A automatically. Therefore, the time spent on adding and registering dictionary data to the self-shop dictionary file 15A is shortened.

Further, the present invention is not limited to the embodiment above.

For example, in the embodiment above, the network server 31 and the dictionary management server 32 are arranged in the cloud system 3, however, the shop server 12 may be endowed with functions of the network server 31 and the dictionary management server 32 so as to construct a network between each shop server 12 and the central server 4 without using the cloud system 3.

Further, in the embodiment above, the central server 4 and another shop server 12B are illustrated as an external server for the self-shop server 12A, however, either of the central server 4 and the another shop server 12B may be used as an external server.

Further, in the embodiment above, the digital video camera 16 is exemplarily used as the image capturing module for the shop server 12, and the touch panel 17 as an operation/output module, however, the image capturing module and the operation/output module are not limited to this case. For example, a multi-functional portable terminal provided with a camera or a high-end cellular telephone may be both used as the image capturing module and the operation/output module.

Further, in the embodiment above, a recognition dictionary processing program is pre-recorded in the auxiliary storage section 75 serving as a program storage section in the apparatus to achieve the functions of the present invention. However, it is not limited to this case, the same program can also be downloaded to the apparatus from a network. Alternatively, the same program recorded in a recording medium can also be installed in the apparatus. For a recording medium, so long as it is an apparatus which can store the program like a CD-ROM and a memory card and the like, and is apparatus-readable, its form is not limited. Further, functions acquired by an installed or downloaded program can be also realized by synergistically acting with the OS (Operating System) and the like inside the apparatus.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A recognition dictionary processing apparatus, comprising:
an extraction module configured to extract feature amount of a commodity contained in image captured;
a candidate recognition module configured to compare the feature amount data stored in a recognition dictionary file in which feature amount data of commodities are stored to recognize the candidate of the commodity contained in the image;
an output module configured to output the candidate commodity which is recognized by the candidate recognition module as a candidate for the commodity contained in the image; and
a processing module configured to execute a first processing related to the update of the recognition dictionary file of the processing object if the commodity contained in the image does not exist in the candidate commodities output by the output module, a second processing unrelated to the update of the recognition dictionary file of the processing object if the commodity contained in the image exists in the candidate commodities.

2. The recognition dictionary processing apparatus according to claim 1, further comprising:
an acceptance module configured to accept the selection on whether or not the commodity contained in the image exists in the candidate commodities output by the candidate commodity output module, wherein
the processing module executes the first processing if the acceptance module accepts a selection input indicating of the nonexistence of the commodity contained in the image,
the processing module executes the second processing if the acceptance module accepts a selection input indicating of the existence of the commodity contained in the image.

3. The recognition dictionary processing apparatus according to claim 1, wherein
the first processing includes the processing of transmitting the data of the appearance feature amount extracted by the feature amount extraction module to an external server through a network and acquiring a candidate for the commodity contained in the image recognized by comparing the data of the feature amount with the feature amount in another recognition dictionary file in the external server.

4. The recognition dictionary processing apparatus according to claim 3, wherein
the first processing includes the processing of collecting the feature amount data of the selected candidate commodity from the another recognition dictionary file if any candidate commodity is selected from the acquired candidate commodities as the commodity contained in the image.

5. The recognition dictionary processing apparatus according to claim 1, wherein
the second processing includes the processing of notifying that the update of recognition dictionary file of processing object is unnecessary.

6. The recognition dictionary processing apparatus according to claim 1, further comprising:
a request acceptance module configured to compare the data of the appearance feature amount received along with the request for a candidate commodity accepted via the external server with the feature amount data of the recognition dictionary file of the processing object to recognize a candidate commodity and output the data of the candidate commodity to the request source.

7. A recognition dictionary processing method, comprising:
extracting a feature amount of the commodity contained in an image captured;
comparing the extracted feature amount data with feature amount data of commodities stored in a recognition dictionary file that stores feature amount data of commodities representing surface information of commodities to extract a candidate of the commodity contained in the image;
outputting the candidate commodity which is recognized as a candidate for the commodity contained in the image; and
executing a first processing related to the update of the recognition dictionary file of the processing object if the commodity contained in the image does not exist in the candidate commodities output by the output module, a second processing unrelated to the update of the recognition dictionary file of the processing object if the commodity contained in the image exists in the candidate commodities.
